(19) United States
(12) Patent Application Publication
(10) Pub. No.: US 2017/0369206 A1
(43) Pub. Date: Dec. 28, 2017

(54) NOZZEL AND ACTUATOR FOR PORTABLE FUEL CONTAINERS

(71) Applicant: DBH Enterprises, Inc., Newton, MA (US)

(72) Inventors: Mark BERMINGHAM, Windham, NH (US); Erik DIEKMANN, Boston, MA (US)

(21) Appl. No.: 15/534,911

(22) PCT Filed: Dec. 17, 2015
(86) PCT No.: PCT/US2015/066454

§ 371 Date: Jun. 9, 2017

Related U.S. Application Data
(60) Provisional application No. 62/093,188, filed on Dec. 17, 2014.

(51) Int. Cl. B65D 25/48; B65D 47/20; B65D 47/24; B65D 25/38; B67D 7/54; B67D 7/00; B67D 7/04

(52) U.S. Cl. CPC B65D 25/48; B65D 47/249; B65D 47/2075; B65D 47/241; B65D 25/385; B67D 7/005; B67D 7/04; B67D 7/54

(57) ABSTRACT

A portable fuel container is disclosed that includes a paddle actuator that is depressible into an engaged position, whereby fluid may only be removed from the container while the paddle actuator is being depressed.

### PRIORITY

The present application claims priority to U.S. Provisional Patent Application Ser. No. 62/093,188 filed Dec. 17, 2014, the disclosure of which is hereby incorporated by reference in its entirety.

### BACKGROUND

The invention generally relates to spouts on portable fuel containers (PFCs), and relates in particular to valves and actuators for such spouts.

Spouts on current PFCs require the user to grab the spout with their hand and apply force in order to pull the outer sleeve of the spout toward the egress on the can. The motion of moving the outer sleeve closer to the egress opens the valve inside the spout. In order to get the fluid to pour out of the can however, the user must pull the sleeve toward the can while simultaneously applying horizontal force to lift the PFC as well as vertical rotational force to pour. This combination requires significant dexterity and strength to accomplish transferring fluids from a PFC into a target appliance.

The innovation described in the contents of this invention specifically focus on improving the user experience by lessening the force and dexterity required to engage valve open/close operations in conjunction with transferring fluids from a PFC into a target appliance.

Further, the current valves for Portable Fuel Containers require that the user pull the sleeve of the valve towards the can with their hand in order to engage the valve and allow fluid to flow out of the can. This can be physically difficult to do and makes it cumbersome and awkward for the user to engage the valve, in essence, the current method is ergonomically inefficient.

There remains a need to addresses how the valve becomes engaged and allows fluid to be emptied from the PFC. There further remains a need for an improved spout and valve arrangement for portable fuel containers.

### SUMMARY

In accordance with an embodiment, the invention provides a portable fuel container comprising a paddle actuator that is depressible into an engaged position, whereby fluid may only be removed from the container while the paddle actuator is being depressed.

In accordance with another embodiment, the invention provides a valve assembly for a portable fuel container. The valve includes a center push rod that pushes a valve plunger against a spring when an outer valve housing is moved toward the container, and wherein the valve body includes channels permitting a fluid within the container to move past the valve plunger when the outer valve housing moved toward the container, whereby fluid may only be removed from the container while the center push rod is being depressed.

In accordance with a further embodiment, the invention provides a portable fuel container that includes a spout on a lower portion thereof as well as an actuator, wherein the spout permits fluid to be removed from the portable fuel container only while the actuator is being depressed.

### BRIEF DESCRIPTION OF THE DRAWINGS

The following description may be further understood with reference to the accompanying drawings in which:

FIG. 1 shows an illustrative diagrammatic isometric view of a portable fuel container in accordance with an embodiment of the present invention;

FIG. 2 shows an illustrative diagrammatic side view of the portable fuel container of FIG. 1 in the gravity assisted fluid egress position;

FIG. 3 shows an illustrative diagrammatic sectional view of the nozzle portion of the portable fuel container of FIG. 1;

FIG. 4 shows an illustrative diagrammatic isometric view of a portable fuel container in accordance with another embodiment of the present invention;

FIG. 5 shows an illustrative diagrammatic isometric view of the portable fuel container of FIG. 4 with the paddle actuator can be folded into disengaged position;

FIG. 6 shows an illustrative diagrammatic isometric view of the portable fuel container of FIG. 4 showing the connection of the paddle actuator to the container;

FIG. 7 shows an illustrative diagrammatic isometric view of the portable fuel container of FIG. 4 with the spout removed;

FIG. 8 shows an illustrative diagrammatic side view of the portable fuel container of FIG. 4 in the gravity assisted fluid egress position.

FIG. 9 shows an illustrative diagrammatic isometric view of the nozzle of the embodiment shown in FIG. 4 showing the outer moveable nozzle and cap together with locking posts;

FIG. 10 shows an illustrative diagrammatic sectional view of the nozzle of the embodiment shown in FIG. 4;

FIG. 11 shows an illustrative diagrammatic isometric view of the nozzle of the embodiment shown in FIG. 4 showing the engagement of the valve operation by the paddle actuator;

FIG. 12 shows an illustrative diagrammatic sectional view a portion of the nozzle of the embodiment shown in FIG. 4;

FIG. 13 shows an illustrative diagrammatic sectional view of the nozzle of the embodiment shown in FIG. 4 showing the spout and valve in the closed position;

FIG. 14 shows an illustrative diagrammatic sectional view of the nozzle of the embodiment shown in FIG. 4 showing the spout and valve in the open position;

FIG. 15 shows an illustrative diagrammatic sectional view of the nozzle of the embodiment shown in FIG. 4 showing how the paddle actuator slides over and around the spout;

FIG. 16 shows an illustrative diagrammatic view of the valve within the nozzle of the embodiment shown in FIG. 4;

FIG. 17 shows an illustrative diagrammatic isometric front view of the valve body of the nozzle of the embodiment shown in FIG. 4; and

FIG. 18 shows an illustrative diagrammatic isometric rear view of the valve body of the nozzle of the embodiment shown in FIG. 4.

The drawings are shown for illustrative purposes only.

### DETAILED DESCRIPTION

In accordance with various embodiments, the invention provides a unique spout design for engaging PFC fluid transfer operations. The current innovation leverages a valve operation that is ergonomically designed to be engaged by depressing a paddle mechanism/actuator which, when engaged, depresses an outer sleeve of a spout affixed to a PFC to open a valve and commence fluid flow operations. Containers of the invention include a unique valve aperture that provides channels in the actual valve opening in accordance with certain embodiments. These channels allow a greater fluid volume cavity that will accelerate fluid flow rates from within the can body to the target appliance. Accelerating fluid flow has a direct benefit to the end-user as the process of transferring fluids from the PFC to the target appliance is expedited. Accelerating fluid flow has a direct benefit to the end-user as the process of transferring fluids from the PFC to the target appliance is expedited.

The current invention in accordance with certain embodiments leverages a paddle actuator that is designed to make contact with the outer sleeve of the spout to facilitate valve open/close operations. This paddle actuator is intended to replace direct user applied force to open the valve in the spout. Leveraging a paddle actuator significantly lessens the amount of user supplied force required to operate the spout. Additionally, locating the paddle actuator separate from the actual sleeve on the spout allows for effective use of leverage which lessens the amount of user supplied force required. Finer control over valve operations are also achieved by utilizing this mechanism as the small force required to engage valve open/close operations allows the operator to gain more control over the valve and thus the volume of fluids transferring between the PFC and the target appliance.

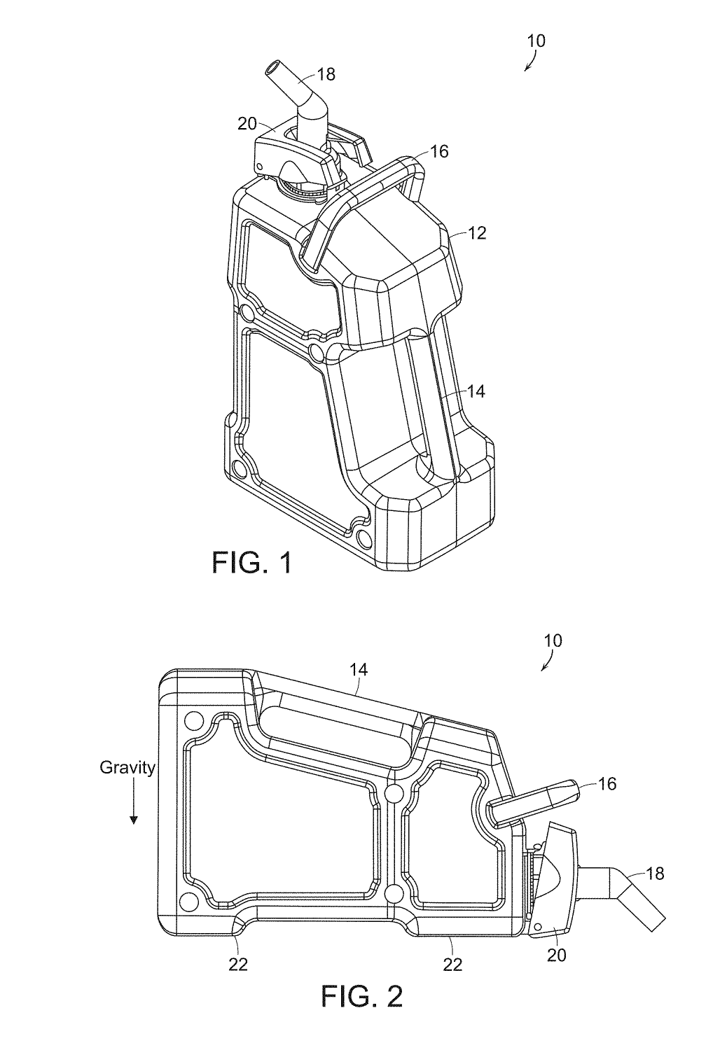

With reference to FIGS. 1-3, in accordance with an embodiment, the invention provides a portable fuel container 10 that includes a container body 12, a primary handle 14, a secondary handle 16, a spout 18 and a paddle actuator 20. As shown in FIG. 2, the container may rest on a bottom surface 22 such that when the valve in the spout 18 is opened, the gravity may assist in flowing fluid from within the container.

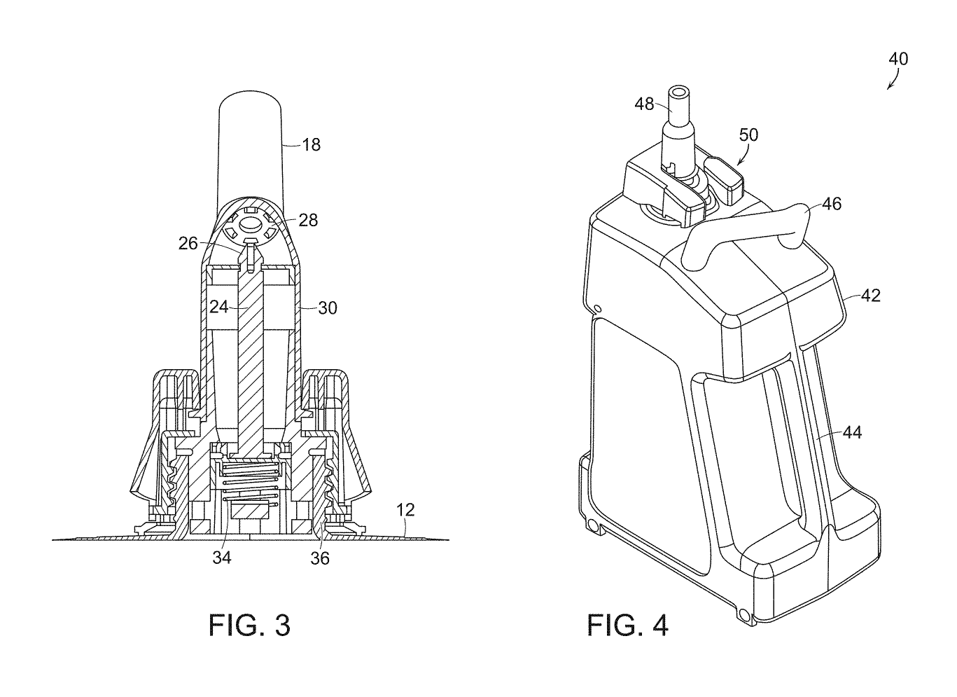

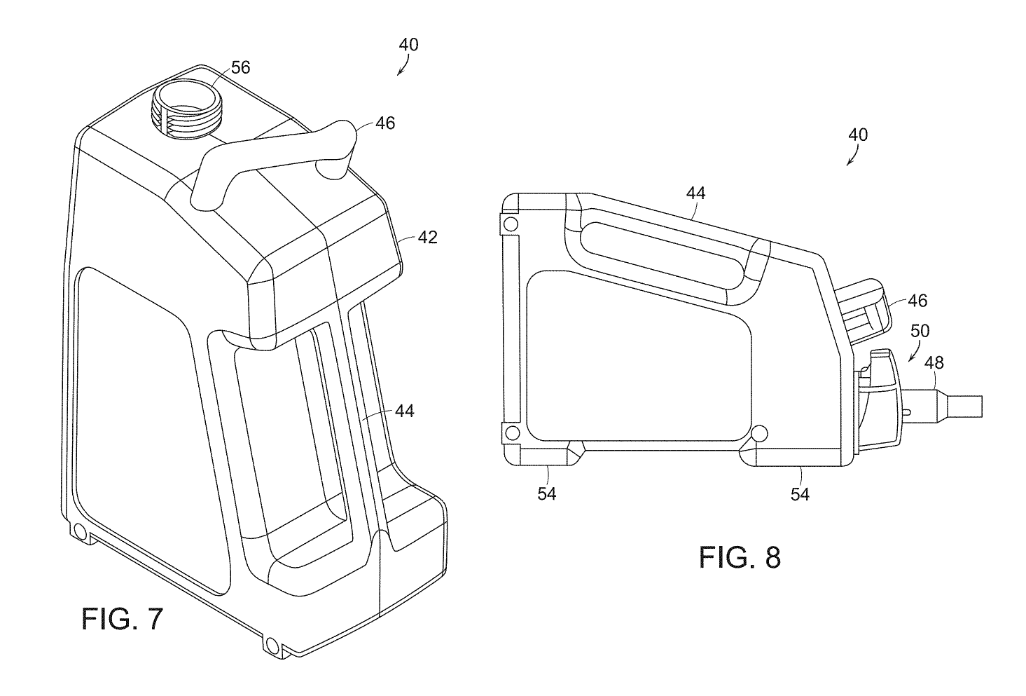

As further shown in FIG. 3, the spout 18 includes a center push rod 24 with a head 26 and an inner ring 28, as well as a movable nozzle 30 that is coupled to a paddle actuator 32. In use, depressing the paddle actuator slides the valve assembly downward (in the drawing) against a bias spring 34 to permit fluid to flow out through the spout 18. The assembly is threaded onto external threads on a spout mount 36 on the container (as shown in the embodiment shown in FIG. 7). Further details regarding the functionality of the valve assembly of the embodiment of FIGS. 1-3 are the same as the functionality of the valve assembly of the embodiment of FIGS. 4-18.

The paddle actuator is designed to be U-shaped and to slip around the actual spout and engage the valve operation at points on the out sleeve of the valve. In contrast, current spout operations require the user have direct hand contact on the valve mechanism which requires greater force transfer to open the spout valve and commence fluid operations.

Additionally, to facilitate fluid displacement operations in existing PFCs the user is required to engage this spout valve while applying both horizontal lift and vertical rotational force. The current innovation leverages a paddle actuator to more easily facilitate mechanical interaction with valve operations and therefore require very little user-applied valve interaction force. Through interaction with the paddle actuator, leverage is applied via a spring mechanism to accelerate mechanical force applied to engage the spout sleeve valve opening and therefore minimize the burden on the end-user. This is a much more ergonomic and innovative way to engage the valve sleeve affixed to the spout.

The paddle actuator described is designed to slide over and around the spout to contact the spout sleeve. Depressing the paddle actuator transfers force through the actuator to the spout sleeve and in turn operates the valve open/close mechanism. Depressing the paddle actuator forces the valve sleeve down which operates in line with the valve mechanism to open the valve and allow fluid transfer from the attached PFC into a target appliance. Removing pressure from the paddle actuator immediately closes the valve thru a spring mechanism incorporated in the valve which facilitates open/close operation.

For example, the paddle actuator allows the user to easily apply two fingers to and from the paddle actuator to engage/disengage the paddle actuator's contact with the spout valve. This mechanical operation engages the valve included in the spout design to enable and cease the expulsion of fluids from the PFC. Utilizing this mechanism ensures that leverage may be effectively used to amplify the force delivered by the operator to more easily engage spout valve open/close operations.

Further, in accordance with various embodiments, the invention further involves moving the location of the egress of a portable fuel container in order to facilitate emptying the contents of the container as shown in FIG. 2. The container relocates the egress and spout location for displacing fluids from a portable fuel container from the top of a container to the bottom of the container (when engaging the current invention for displacing liquids from a container). The location has been moved and is significantly relevant for the initiation of fluid flow operations.

The egress and spout located at the bottom of the portable fuel container leverages gravity to power expelling fluids from the portable fuel container instead of having to apply vertical rotational force to the container to empty its' contents. In this way the user is no longer pouring liquids but has instead created a gravity-reliant innovation that revolutionizes fluid displacements from a portable fuel container. The invention therefore involves changing the dynamics of expelling fluids from a portable fuel container from requiring both vertical and horizontal forces, to one which only requires horizontal lift and thus the operator simply displaces fluids from a container into the target appliance. This is a much simpler, ergonomic, and more effective solution. This, in combination with the paddle actuator, permits a user to simply depress the paddle actuator when the container is positioned along its bottom surface (as shown in FIGS. 2 and 8). In addition, containers of the invention have several channels within the valve. This increases the flow rate of the fluid coming out of the PFC.

Again, the paddle actuator works in conjunction with the spout valve to deliver amplified force to open the spout valve. Additionally, fine valve control is facilitated through this mechanism as lessened force requirements translates directly into greater fluid flow control.

Again, it's important to state that leveraging this mechanism ensure the lessening of force amplification that is required to be supplied directly by the operator. This is particularly important to expelling fluid contents from a PFC where horizontal lift and vertical rotational force are also required to facilitate PFC operation

The paddle actuator is strategically affixed directly adjacent to a PFC handle contact point such that the paddle may be very simply depressed while the user simultaneously contacts the PFC handle to apply balance and targeting required to steer the PFC spout fluid egress point into the target appliance.

The paddle actuator is affixed to the PFC directly adjacent to the aperture opening. The paddle actuator may be folded into transport/store/fill position such that accidental operation of valve operation thru interaction with the valve sleeve open/close procedure is eliminated. This purposeful design is intended to render the valve inoperable during storage/transport and therefore impossible to accidentally engage and spill fluids or vent gasses without the operator intending to initiate fluid displacement operations. This design will eliminate accidental engagement of fluid initiation activities when the PFC suffers accidents or misuse. This will significantly reduce accidental valve opening more common with spout mechanisms that affix valve open/close operation directly on the spout.

Leveraging this mechanism is anticipated to result in significantly less spillage and thus lessened PFC leakage rates and environmental impacts. Incorporating a paddle actuator that is purposely separated from the spout/valve ensures a safer, easier and more ergonomic valve open close operation for expelling fluids from a PFC.

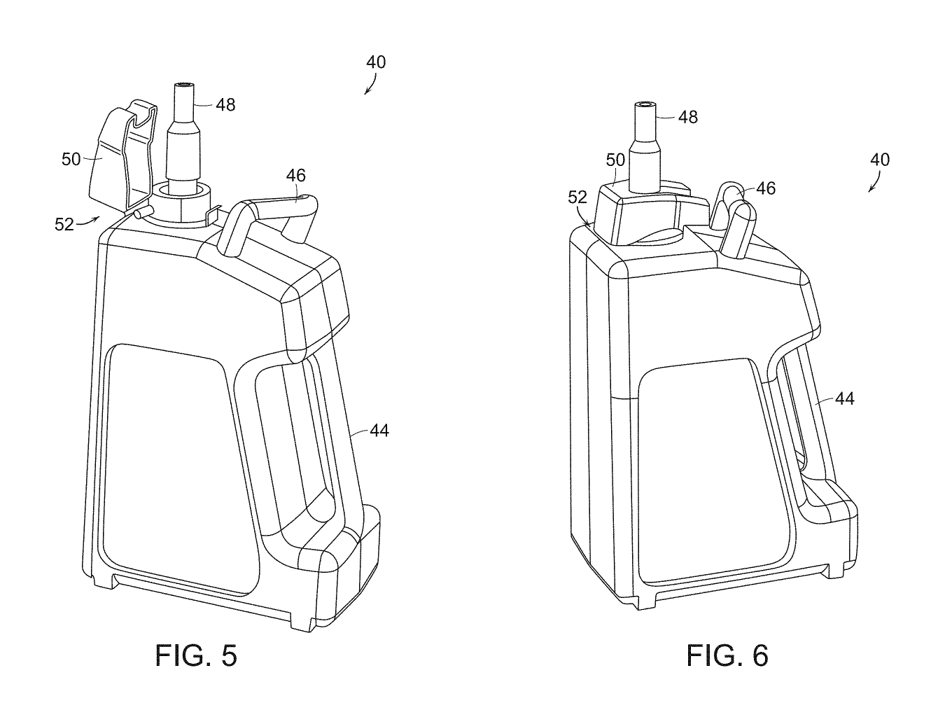

With reference to FIG. 4, a portable fuel container 40 in accordance with another embodiment of the present invention includes a container body 42, a primary handle 44, a secondary handle 46, a spout 48 and a paddle actuator 50. The paddle actuator 50 enables the operator to engage valve open/close operation is affixed to an alternate contact point on the PFC separated from the spout. This ensures that leverage may be effectively used to apply force to facilitate valve open/close operations within the spout. As shown in FIGS. 5 and 6, the paddle actuator 50 may be folded along a hinge 52 into transport/store/fill position such that accidental operation of valve operation thru interaction with the valve sleeve open/close procedure is eliminated. The paddle actuator is designed to be affixed to the can near the aperture opening of the PFC and is designed to be folded into operational position for fluid flow operations. The spout is attached to a threaded spout mount 56 as further shown in FIG. 7. The spout may also be removed during transport and replaced with a transport/storage cap.

This purposeful design is intended to render the valve inoperable during storage/transport and therefore impossible to accidentally engage and spill fluids or vent gasses without the operator intending to initiate fluid displacement operations. It is anticipated that this design will eliminate accidental engagement of fluid initiation activities when the PFC suffers accidents or misuse. This will significantly reduce accidental valve opening resulting in improved PFC leakage rates. As shown in FIG. 5, the paddle actuator may be folded into disengaged position to allow the spout to be removed for filling the PFC with fluids.

As shown in FIG. 8, the container may rest on a bottom surface 54 such that when the valve in the spout 48 is opened, the gravity may assist in flowing fluid from within the container. In this embodiment, the paddle actuator has been located coincident with this secondary angled handle 46 when folded into operational location to ensure ease of use/contact with the paddle actuator to engage the spout/valve assembly.

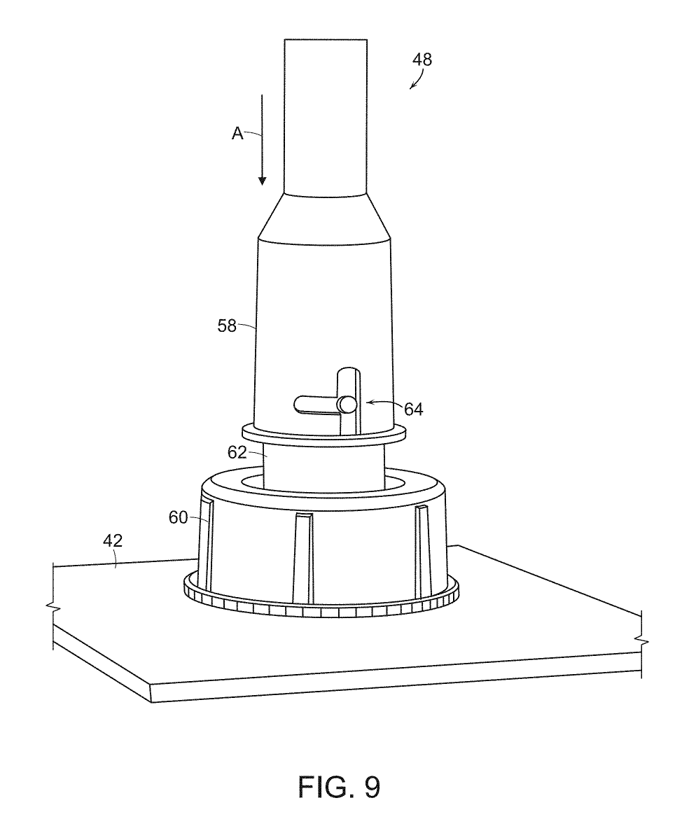

FIG. 9 shows that the spout 48 includes an outer moveable nozzle 58 that moves with respect to a cap 60 and valve body 62. The assembly also includes locking posts 64 as shown for locking the nozzle in a locked position. In particular, the moveable nozzle may be rotated to lock the valve shut (a post and accompanying recess may also be provided on the opposite side that is not shown). When the movable nozzle is pushed in as shown at A, fluid is permitted to exit the container.

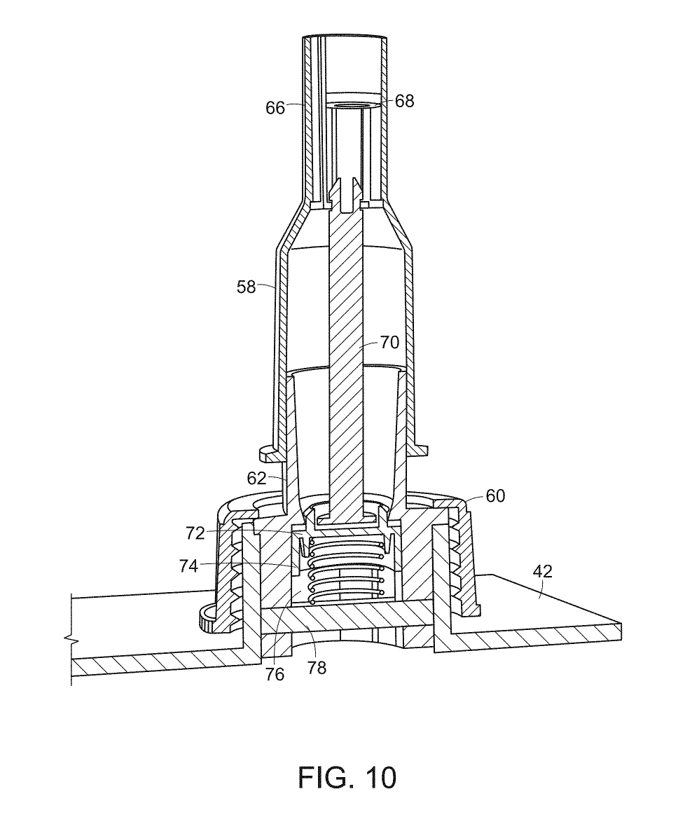

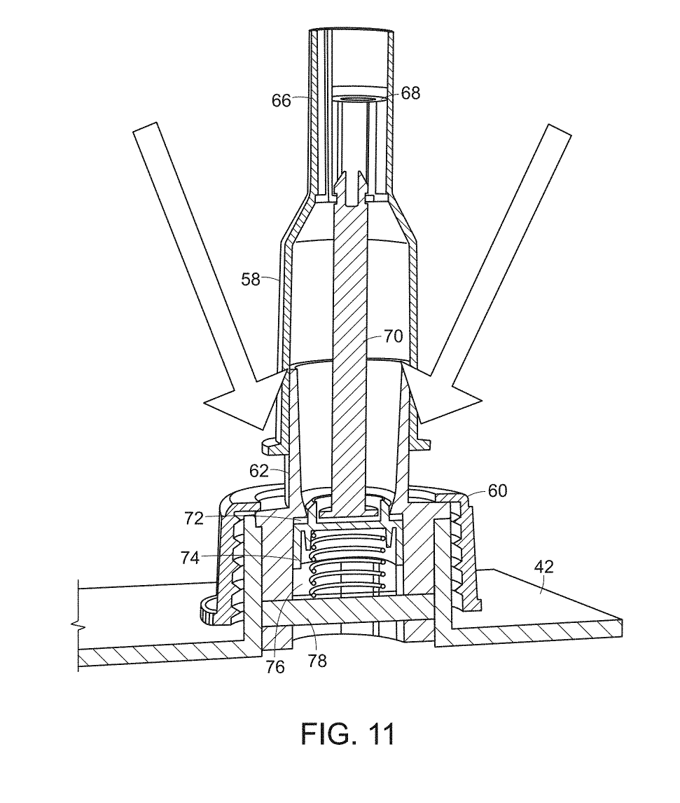

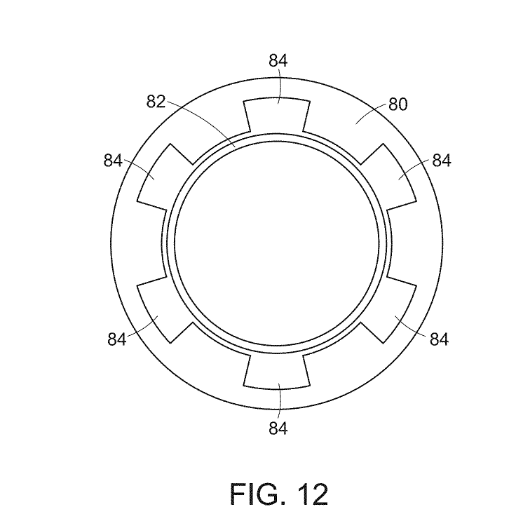

FIG. 10 shows a sectional view including the outer moveable nozzle, center push rod, compression spring and spring retainer. In particular, drawing shows the moveable nozzle 58 as well as the valve body 62, cap 60, spout mount 56 and the container body 42. FIG. 10 also shows the an air passage 66 for permitting displacement air to enter the container, a flame arrestor screen 68, a center push rod 70, an O-ring 72, a valve plunger 74, a compression spring 76 and a spring retainer 78. The paddle actuator is designed to be u-shaped and slip around the actual nozzle and engage the valve operation at the points indicate by the arrows B in FIG. 11. FIG. 12 shows an end view of the valve body 80 and the valve plunger 82 showing the channels 84.

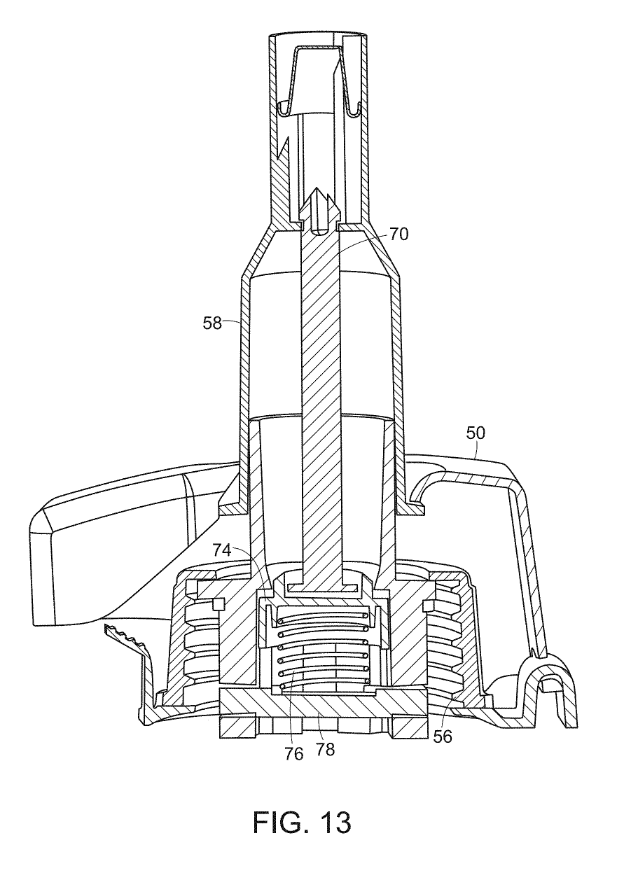

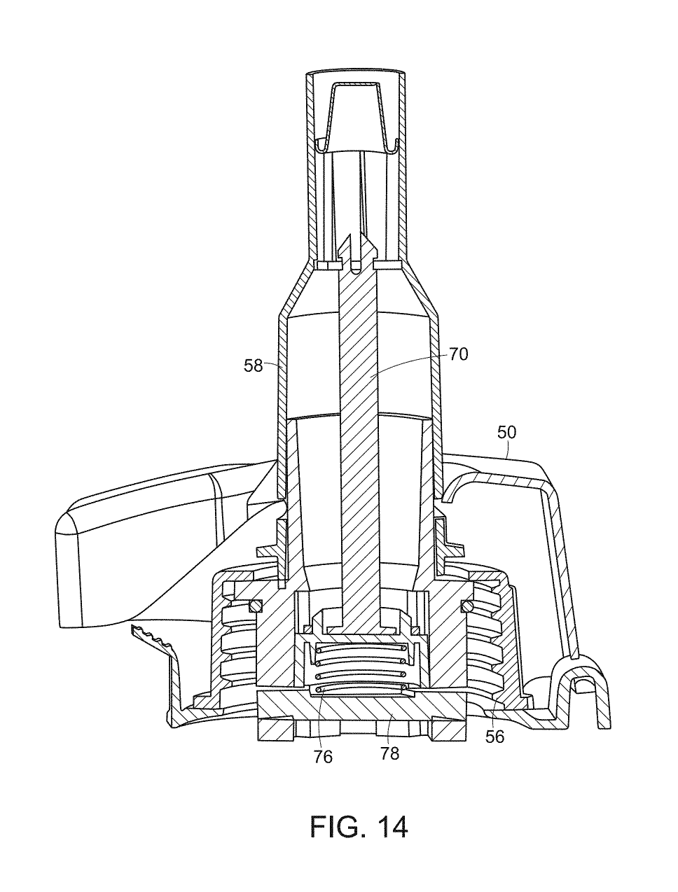

FIG. 13 shows a sectional view of the spout and valve in the closed position wherein the valve plunger 74 is pushed by the spring 76 so as to close the valve. FIG. 14 shows a sectional view of the spout and valve in the open position where the valve plunger 74 is pushed against the spring 76 to maintain the valve as open.

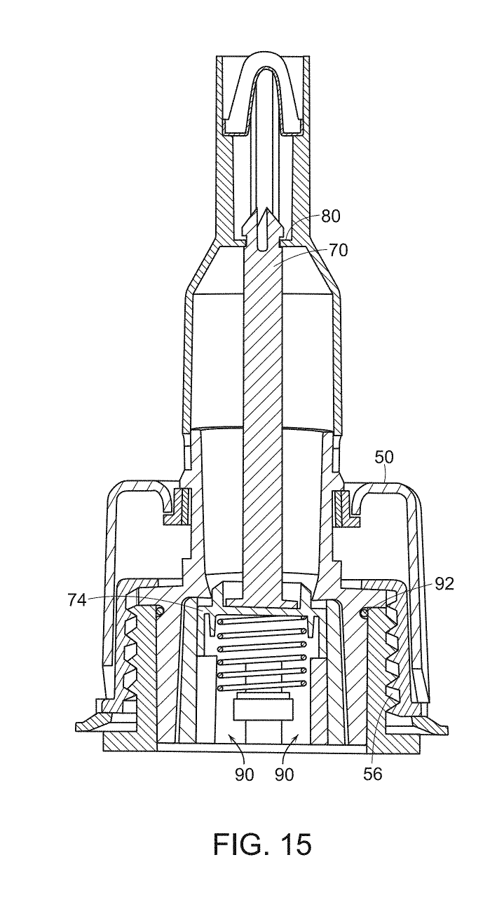

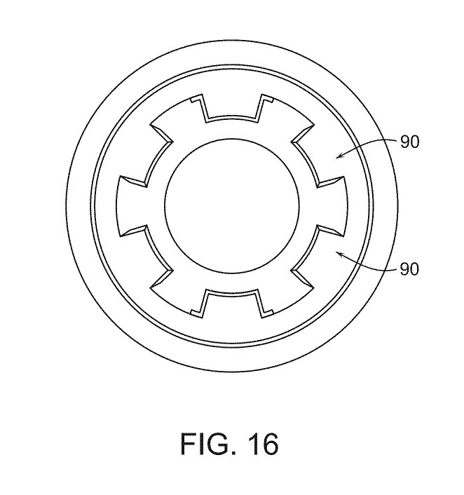

FIG. 15 shows a further sectional view of the spout showing the channels 90 through which fluid may pass when the valve plunger 74 is depressed (actuated). The paddle actuator slides over and around the spout. The paddle actuator works in conjunction with the spout to open and close the valve inside the spout. Depressing the paddle actuator contacts the spout sleeve exerting down pressure on the spout sleeve to facilitate valve open operation which allows fluid flow to commence. Releasing the paddle actuator will close the valve in the spout. Additionally, fine valve control is facilitated through this mechanism. The channels are located along the entire perimeter of the valve aperture. As further shown in FIG. 16, the channels 90 are purposely tooled into the valve aperture to provide a larger fluid flow volume through the valve aperture.

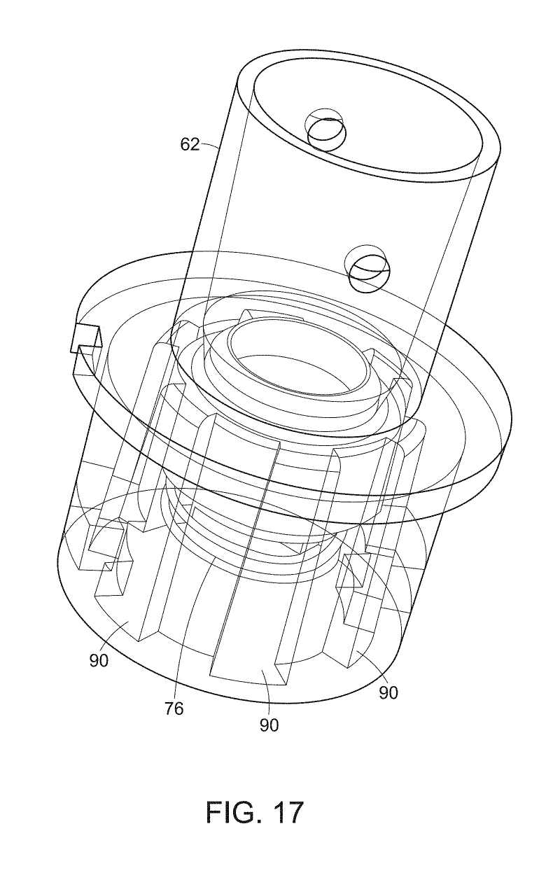

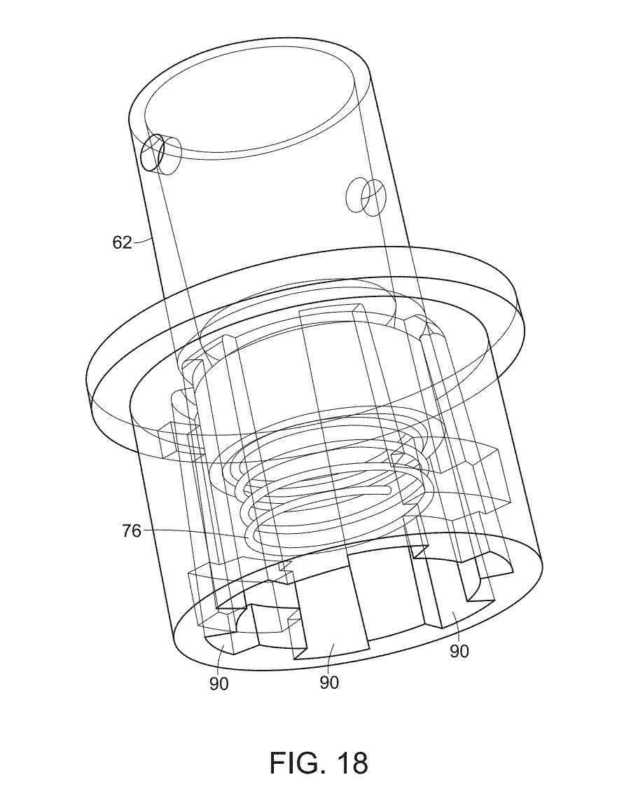

When the valve is closed these channels 90 will be completely sealed and not allow any fluids to flow through the aperture. The design and use of the paddle makes it much easier and more ergonomically functional to engage the spout and allow fluid to pour out of the PFC. The Paddle Actuator pushes down on the outer sleeve of the spout which causes the valve to open and allow fluid to flow out of the can. When paddle actuator is released and it is no longer pressing down on the outer sleeve of the spout, the channels inside the valve close and no fluid can exit the PFC. The valve of the current embodiment has six channels inside of it allowing for more fluid to flow out of the PFC and at a faster rate. This minimizes the amount of time the user has to spend transferring fluid from the PFC into the target appliance. FIG. 17 shows a front perspective open view of the valve body, and FIG. 18 shows a rear perspective open view of the valve body showing the structure that forms the channels 90.

During use, therefore, the user rests the paddle actuator against a receiving opening (such as a tank of a system that includes a combustion engine), and the paddle actuator is pushed toward the portable fuel container, rotating about the hinged mount on the container as shown in FIGS. 5, 6 and 8. As shown in FIG. 15, the paddle actuator has contact points 92 that urge the outer movable nozzle toward the container. The movable nozzle includes an inner ring at a distal end thereof that captures a head of a center push rod. This action urges the center push rod to be drawn toward the container against the force of a spring (against a spring retainer) as shown in FIG. 10. When the base of the center push rod is pushed in this direction, a valve plunger (again, shown in FIG. 10) moves away from an O-ring and pushes against the spring. The walls of the opening through which the valve plunger moves, includes channels as shown in FIGS. 11, 12, 15, 16, which permit the fluid to pass around the plunger and enter the area defined by the valve body and the moveable nozzle, surrounding the center push rod. As shown in FIG. 9, the outer valve housing may be locked into a locked position whereby the paddle actuator may not cause the outer valve housing from being moved into an engaged position.

At the distal end, the inner ring of the moveable nozzle includes openings (as shown in FIG. 15) through which the fluid may be provided. In further embodiments, the nozzle may also include a flame arrestor screen as shown in FIG. 11. Such a screen is designed to disturb and therefore stop any flame that runs up along the fuel and tries to enter the container. As shown in FIG. 10, the spout may also include a passage by which air may be drawn into the container to displace volume vacated by liquid that has be poured out of the container.

Those skilled in the art will appreciate that numerous modifications and variations may be made to the above disclosed embodiments without departing from the spirit and scope of the present invention.

What is claimed is:

1. A portable fuel container comprising a paddle actuator that is depressible into an engaged position, whereby fluid may only be removed from the container while the paddle actuator is being depressed.

2. The portable fuel container as claimed in claim 1, wherein said paddle actuator includes an inner shoulder portion for contacting and thereby moving an outer housing of a nozzle.

3. The portable fuel container as claimed in claim 2, wherein said outer housing is coupled to a center push rod that pushes a valve plunger against a spring when the outer housing is moved toward the container.

4. The portable fuel container as claimed in claim 3, wherein said valve plunger moves within a valve body, and wherein the valve body includes channels for permitting the fluid to move past the valve plunger when the paddle actuator is depressed into the engaged position.

5. The portable fuel container as claimed in claim 4, wherein said outer housing may be locked in a closed position such that the paddle actuator may not be engaged.

6. The portable fuel container as claimed in claim 5, wherein said outer housing includes a flame arrestor screen.

7. The portable fuel container as claimed in claim 2, wherein said nozzle is positioned near a base of the portable fuel container to facilitate removing fluid from the portable fuel container.

8. A valve assembly for a portable fuel container, said valve comprising a center push rod that pushes a valve plunger against a spring when an outer valve housing is moved toward the container, and wherein the valve body includes channels permitting a fluid within the container to move past the valve plunger when the outer valve housing moved toward the container, whereby fluid may only be removed from the container while the center push rod is being depressed.

9. The valve assembly as claimed in claim 8, wherein said portable fuel container further includes a paddle actuator for engaging the outer valve housing.

10. The valve assembly as claimed in claim 9, wherein said outer valve housing included locking means for securing the outer valve housing in a locked position such that the paddle actuator may not move the outer valve housing into an engaged (open) position.

11. The valve assembly as claimed in claim 9, wherein the paddle actuator is rotatably attached to the container.

12. A portable fuel container that includes a spout on a lower portion thereof as well as an actuator, wherein said spout permits fluid to be removed from the portable fuel container only while the actuator is being depressed.

13. The portable fuel container as claimed in claim 12, wherein said actuator includes an inner shoulder portion for contacting and thereby moving an outer housing of a nozzle.

14. The portable fuel container as claimed in claim 13, wherein said outer housing is coupled to a center push rod that pushes a valve plunger against a spring when the outer housing is moved toward the container.

15. The portable fuel container as claimed in claim 14, wherein said valve plunger moves within a valve body, and wherein the valve body includes channels for permitting the fluid to move past the valve plunger when the paddle actuator is depressed into the engaged position.

16. The portable fuel container as claimed in claim 15, wherein said outer housing may be locked in a closed position such that the paddle actuator may not be engaged.

17. The portable fuel container as claimed in claim 16, wherein said outer housing includes a flame arrestor screen.
